(19) United States
(12) Patent Application Publication
(10) Pub. No.: US 2012/0228801 A1
(43) Pub. Date: Sep. 13, 2012

(54) INJECTION METHOD FOR HOLLOW PRODUCTS, ITS FUSIBLE CORE AND THE METHOD FOR MAKING THE FUSIBLE CORE THEREOF

(76) Inventor: Xiangji WANG, Xiamen (CN)

(21) Appl. No.: 13/197,861

(22) Filed: Aug. 4, 2011

(30) Foreign Application Priority Data
Mar. 11, 2011 (CN) 201110060487.9

(51) Int. Cl. B29C 45/00; B29D 22/00; B22D 25/00; B29C 33/76; B22D 23/06; B22D 29/00

(52) U.S. Cl. 264/328.1; 164/6; 249/175

(57) ABSTRACT

An injection method for hollow products, a fusible core and the method for making the fusible core comprises putting a fusible Sn—Bi alloy core into a mold core, then both the product and the fusible core are taken out from the die. The fusible core is turned from solid to liquid state and is apart from the product. The inner wall of the core can be made using this method, and the plastic product can be with more shape in one-step molding to replace the metal in many fields. Complex core-pulling mechanism is not needed, thus the core structure is simplified, and the shape of die can be simplified. The fusible core is not needed to be maintenance for it will not be worn, because after each injection, the fusible core is recycled to make a new fusible core.

### FIELD OF THE INVENTION

The present invention relates to an injection method for hollow products, the fusible core for the injection method, and the method for making the fusible core.

### BACKGROUND OF THE INVENTION

In injection molding, products with complex inner walls will involve core-pulling technology, by movable core, the product can form the complex structure and the core is convenient to be pulled out from the die. The core-pulling technology has the following disadvantages: the mold core which can be used in core-pulling process, it core must be specially designed so that it can be pulled out from the inside of the product, this in one hand make the movable structure of the mold core be complex, and in the other hand, the shape of the mold core is limited by the core-pulling act, thus the product with some special inner-wall structure cannot be realized by the core-pulling technology. To overcome these shortages, normally, the products are designed to be not one-step molding, but achieved by being assembled by each one-step molding components; this will bring another problem: because the product is not one-step molding, so the connecting points between the components is not enough both in strength ability and in sealing ability. One of the example is all kinds of the main structure of the valves: the main structure comprises kinds of passageways for liquid, and the inner wall is loop in and out, so the main structure can not be completed by the core-pulling technology of injection. And if the method that assembly by components is used, the strength and the sealing ability are not enough, under this condition, the structures of many valves still just only can be made by metal casting, and the cost is high during to the high price of the raw material.

So, although the ability of plastic is excellent in many aspects, in some fields even well than the metal, but limited by the injection technology, the plastic still can not be widely used in some field that it may be used. Thus there is a need for improving the traditional injection technology to realize the product with complex inner walls and can not be made by core-pulling technology.

### SUMMARY OF THE INVENTION

According to above requirement, the present invention provides an injecting method for hollow products, and the fusible core for the injection method thereof, and the method for making the fusible core.

The solution is:

An injecting method for hollow product comprising:

1) installing the fusible core: before the die being closed, the fusible core made of fusible alloy is installed in the die;

2) taking out the product: both the product and the fusible core are taken out from the die;

3) taking out the fusible core: the fusible core is turned from solid status to liquid status and is apart from the product;

Herein the material of said fusible core is alloy comprising Bi (bismuth) and Sn (stannum), and the melting point of the alloy is lower than the softening point of the product, and the thermal conductivity is higher than that of the product.

As an improved solution, the present invention can be:

In a preferred embodiment, the step of taking out the fusible core comprising a physical heating process, in the process the product is in a temperature that the fusible core can heated to liquid.

In a preferred embodiment, the step of taking out the fusible core comprising a process of dissolve in water bath, in this process the product is disposed in a hydrophobic liquid, thus said fusible core can be dissolved in hydrophobic liquid.

In a preferred embodiment, the step of taking out the fusible core comprising a process of dissolve in oil bath, in this process the product is disposed in oil liquid, thus said fusible core can be dissolved in the oil liquid.

In a preferred embodiment, further comprising a cleaning step after the step of taking out the core: in said cleaning step the remained portion of the fusible core in product is cleaned.

In a preferred embodiment, further comprising a recycle step after the step of taking out the core: in said recycle step all of the components of the fusible core are recycled from the liquid containing the core, and the components reused for making the metal for fusible core.

The solution of the fusible core for injection of the present invention is:

A fusible core for injection is made by Bi—Sn alloy based on Bi,

A fusible core for injection is made by alloy comprising Bi and Sn, and further comprising one of the metals of Pb (lead) or Cr (chromium) or both; herein the rate of Bi to Sn is 2:1 to 1:1.

The melting point of the Sn—Bi alloy is 70° C. to 183° C.

A method for making the fusible core for injection, comprising:

1) mixtures comprising Bi 50%, Pb 25%, Sn 12.5 and Cr 12.5% is put into a container with a temperature over the melting point of the mixture, in this process they are mixed to be equality, and the scum is removed in time.

2) the metal liquid mixed fully is cast to be strip;

3) the striped metal is made to be the fusible core for injection.

The advantages of the present invention:
1. Both the fusible core and the product are take out in a whole, and the fusible core is removed in liquid form, thus the inner wall which can not be made by core-pulling technology can be made, and the plastic product can be with more shape in one-step molding to replace the metal in many field.
2. Complex core-pulling mechanism is not needed, thus the core structure is simplified, and the shape of die can be simplified, the cost is reduced.
3. The fusible core is not needed to be maintenance for it will not be wear, because after each injection, the fusible core is recycled to make new fusible core.
4. The core made of Sn and Bi has lower melting point, and well thermal conductivity relative to plastic material, thus by controlling the injection time will avoid the fusible core being melted in the die, to ensure the shape.
5. The core made of Sn and Bi has lower shrinkage from solid to liquid status, thus the fusible core can be a part with high precision of the mold core.

Preferred embodiment of the present invention will be described in detail with reference to the drawings and examples.

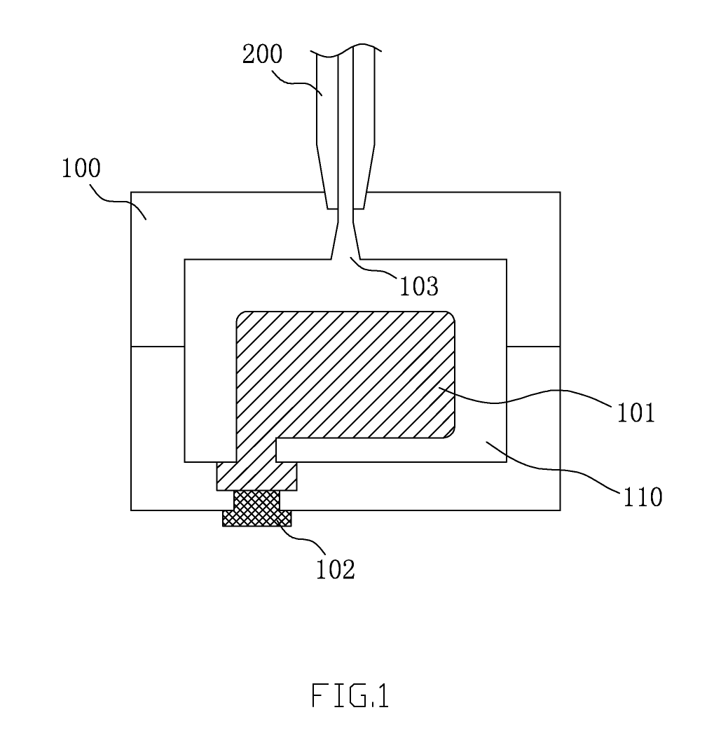

FIG. 1 is working status 1 in a preferred embodiment, which shows the partial sectional view of the die after the die being installed.

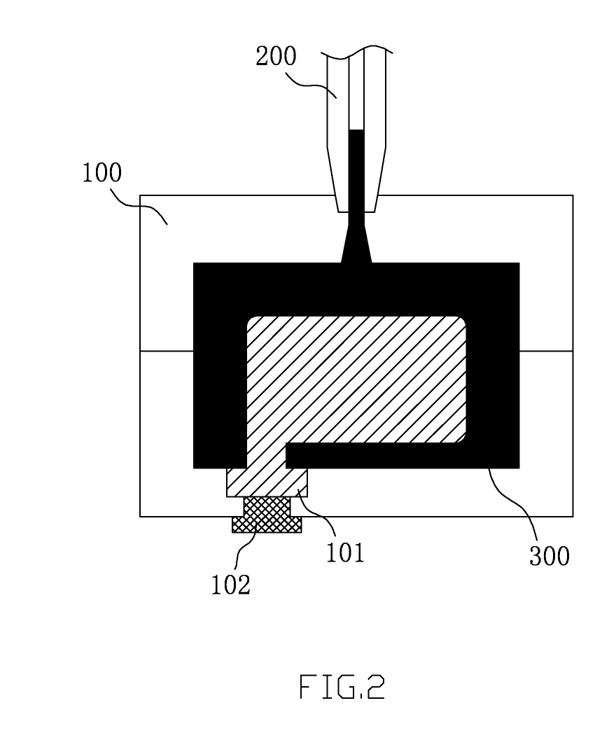

FIG. 2 is working status 2 in a preferred embodiment, which shows the partial sectional view of the die after being cooled.

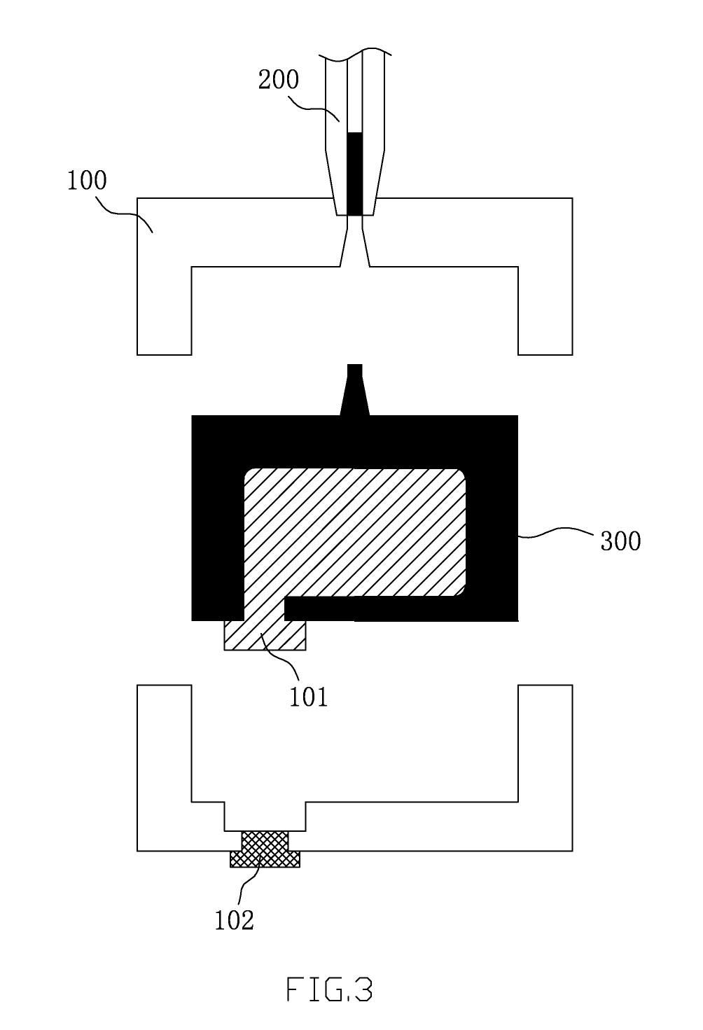

FIG. 3 is working status 3 in a preferred embodiment, which shows the partial sectional view of the die after die-opening step.

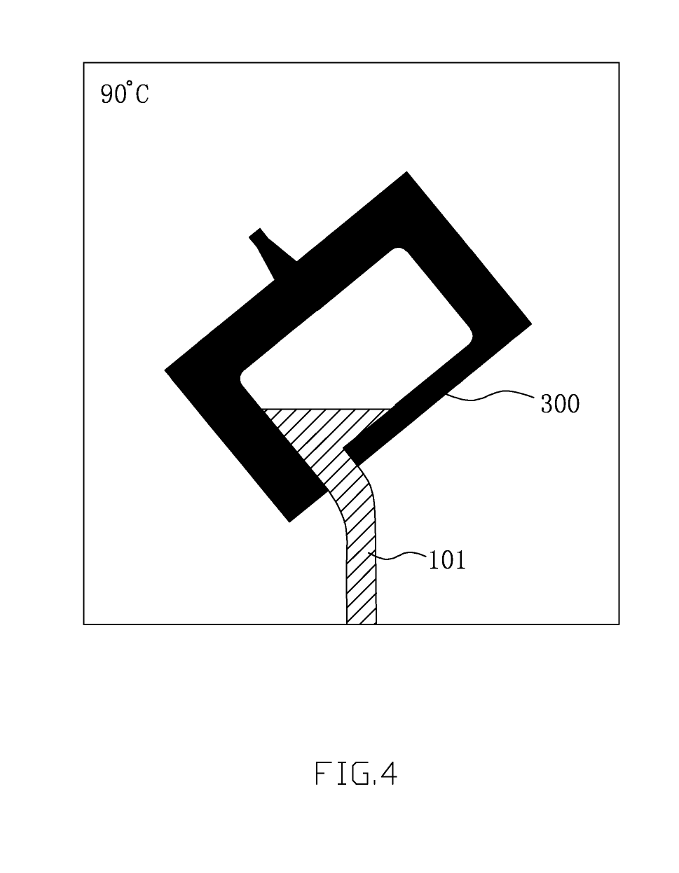

FIG. 4 is working status 4 in a preferred embodiment, which shows the partial sectional view in which the fusible core is removing out.

### DETAILED DESCRIPTION OF THE PREFERRED EMBODIMENT

Referring to FIG. 1, the working status 1 in embodiment, which shows partial sectional view of the die after the die being installed. Herein a whole cavity 110 is provided in the mold core 100, and a fusible core 101 is disposed in the lower portion of the mold core 100, the fusible core 101 is fixed in the inner wall of the cavity 110 in insert by a fixing mechanism 102; the fixing mechanism 102 is a part which can be controlled from the outside of the die, it control the fusible 101 to be fixed to or removed from the mold core 100; the fusible core 101 has structure which can not be core-pulling.

Mold core 100 has a gate 103 which connected to the barrel 200, the injection material can be put into the cavity 110 from the barrel 200 via the gate 103, to be described cleanly, the other needed parts of the die are not shown.

FIG. 2 is the working status 2 in embodiment, which shows the sectional view of the die after the die being injected and cooled; the injection material poured into the cavity from the barrel 200 is formed to be a product 300, and the main portion of the fusible core 101 is embedded in the product 300, limited by the shape of the fusible core, the product 300 has pre-set inner wall structure.

The fusible core 101 is made by alloy which comprising: Bi 50%, Pb 25%, Sn 12.5 and Cr 12.5%, the mixture is put into a container with temperature of 150° C. and is melted and mixed, and the scum is removed in time. After being cooled, the alloy is solid, silvery in room temperature, with melting point 70° C., lower hardness, the shrinkage rate from solid to liquid is 0.051%, well permeability, so the shaped fusible core 101 can ensure enough precise of the injection product.

In this embodiment, the injection material is ABS, when the ABS is in soft status, the temperature is higher than the melting point of the fusible core 101, but in injection, the fusible core 101 will not be deformation. Because the thermal conductivity of the alloy-metal of fusible core 101 is V1, while that of the injection material is V2, V1>>V2, so in the whole process in which the fusible core 101 is embedded in the injection material (the process is from the beginning of the injecting, and is end before the mold core being taking out). By controlling the time of this process, the heat quantity transferred to the fusible core 101 from the injection material will be less enough, so that the fusible core 101 is not reach to the melting point, thus, the shape of the fusible core 101 can be maintained. Herein two abilities of the Sn—Bi alloy are the key factor: one is that the thermal conductivity of the metal is higher than the product, another is that the melting point is lower than the softening point of the product, further, the lower shrinkage is ensure the high precision of the product.

FIG. 3 is the working status 3 in embodiment, which shows the sectional view of the die after the die being injected and cooled; the mold core 100 is opened and apart to the product 300, it is worth notice that the fusible core 101 is apart from the fixing mechanism 102, thus the fusible core 101 is maintained in the product 300 and they are taken out together as a whole from the mold core 100, the fixing mechanism 102 can be controlled from the outside of the die and then released from the fusible core 101.

FIG. 4 is the working status 4 in embodiment, which shows the sectional view of the die when the fusible core is taking out. Both the product 300 and the fusible core 101 are put into an oven with a temperature of 90° C. The temperature will not affect the shape and ability of the product 300, and the fusible core 101 is melted into liquid and flow out from the inside of the product 300. After this status, the inside of the product 300 is cleaned, and the final product 300 is obtained.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

What is claimed is:

1. An injecting method for hollow product comprising:
1) installing the fusible core: before the die being closed, the fusible core made of fusible alloy is installed in the die;
2) taking out the product: both the product and the fusible core are taken out from the die;
3) taking out the fusible core: the fusible core is turned from solid status to liquid status and is apart from the product;
herein the material of said fusible core is alloy comprising Bi and Sn, and the melting point of the alloy is lower than the softening point of the product, and the thermal conductivity is higher than that of the product.

2. The injecting method for hollow product according to claim 1, wherein the step of taking out the fusible core comprising a physical heating process, in the process the product is in a temperature that the fusible core can heated to liquid.

3. The injecting method for hollow product according to claim 1, wherein the step of taking out the fusible core comprising a process of being dissolved in water bath, in this process the product is disposed in a hydrophobic liquid, thus said fusible core can be dissolved in hydrophobic liquid.

4. The injecting method for hollow product according to claim 1, wherein the step of taking out the fusible core comprising a process of being dissolved in oil bath, in this process the product is disposed in oil liquid, thus said fusible core can be dissolved in the oil liquid.

5. The injecting method for hollow product according to claim 2 further comprising a cleaning step after the step of taking out the fusible core: in said cleaning step the remained portion of the fusible core in product is cleaned.

6. The injecting method for hollow product according to claim 1 further comprising a recycle step after the step of taking out the fusible core: in said recycle step all of the components of the fusible core are recycled from the liquid containing the fusible core, and the components reused for making the metal for fusible core.

7. A fusible core for injection is made by Bi—Sn alloy based on Bi.

8. The fusible core for injection according to claim 7 further comprising one of the metals of Pb (lead) or Cr (chromium), or both; herein the rate of Bi to Sn is from 2:1 to 1:1.

9. The fusible core for injection according to claim 8, wherein the melting point of the Sn—Bi alloy is from 70° C. to 183° C.

10. A method for making the fusible core for injection, comprising:
1) mixtures comprising Bi 50%, Pb 25%, Sn 12.5 and Cr 12.5% is put into a container with a temperature over the melting point of the mixture, in this process they are mixed to be equality, and the scum is removed in time;
2) the mixed metal liquid is cast to be strip;
3) the striped metal is made to be the fusible core for injection.

11. The injecting method for hollow product according to claim 2 further comprising a recycle step after the step of taking out the fusible core: in said recycle step all of the components of the fusible core are recycled from the liquid containing the fusible core, and the components reused for making the metal for fusible core.

12. The injecting method for hollow product according to claim 3 further comprising a recycle step after the step of taking out the fusible core: in said recycle step all of the components of the fusible core are recycled from the liquid containing the fusible core, and the components reused for making the metal for fusible core.

13. The injecting method for hollow product according to claim 4 further comprising a recycle step after the step of taking out the fusible core: in said recycle step all of the components of the fusible core are recycled from the liquid containing the fusible core, and the components reused for making the metal for fusible core.

14. The injecting method for hollow product according to claim 5 further comprising a recycle step after the step of taking out the fusible core: in said recycle step all of the components of the fusible core are recycled from the liquid containing the fusible core, and the components reused for making the metal for fusible core.
